(19) United States
(12) Patent Application Publication
(10) Pub. No.: US 2011/0111746 A1
(43) Pub. Date: May 12, 2011

(54) Automaton intelligent robot protector

(76) Inventor: Hsien-Hsiang Chiu, Branchton (CA)

(21) Appl. No.: 12/928,148

(22) Filed: Dec. 6, 2010

Related U.S. Application Data
(62) Division of application No. 10/954,438, filed on Oct. 1, 2004.

(51) Int. Cl. H04W 4/04; H04W 88/02

(52) U.S. Cl. 455/422.1; 455/572; 455/559

(57) ABSTRACT

The intelligent robot device has a computer control center provided with server modules connected to sensors, video cameras, Global Positioning System, and video cell phone communication channels controlled by micro controllers. The intelligent robot automatically makes responsive actions based on an internal programming list to make video cell phone calls, and transfer video in real time and brief situation report to the car owner and police, 911, and emergency ambulance service. The robot device has built-in authenticate encryption process security hardware for listening to specific assigned activate signals of radio wave and digital signals to perform secure activate robot steps.

### FIELD OF THE INVENTION

The present invention relates to an automaton intelligent robot and particularly to a robot applicable to secure remote activation of video cell phone communication. The intelligent robot protector may be incorporated as an integral part or as an accessory of cars and transportations to enable anti theft and anti crime activities. It can automatically make help calls alert and transfer video reporting of the situation in real time to the car owner and police, 911, and medical services.

### BACKGROUND OF THE INVENTION

This Application is a divisional application of pending U.S. application Ser. No. 10/954,438 filed on Oct. 1, 2004.

In our society, we have depended on cars and transportations everyday. Car theft, crime activities, and traffic accidents are the problems that our society is required to solve. The anti car theft device that we use today can only make a loud warning sound and hopefully the thief will shy and run away. The above unsatisfactory solution just gives us a safe feeling of knowing that an alarm device has been installed in the car. A skillful thief can disable the alarm in a flash. Another problem is that in an accident the passengers in the car may be injured and require urgent medical aid, and it will be difficult to seek help themselves or to make telephone calls. The complete solution for all these problems can be provided with an Automaton Intelligent Robot Protector that has a computer control center attached with necessary modules of multiple sensors, video cameras, and GPS. The automaton robot may be built in the car and transportation, so that the robot will watch for the above adverse conditions and will provide appropriate responses accordingly. The robot will automatically decide what to do based on predetermined commands. For Example, When it detects suspicious theft, it will make the video cell phone call to the owner together with a video display; and in the event of a serious traffic accident, the robot can dial telephone call to summon medical 911 attention as well as transferring a video display of the current situation of the accident, and the accident location showing passengers needing medical assistant; therefore the medical 911 service would have a clear idea of sending the correct treatment aid without delay.

### SUMMARY OF THE INVENTION

The Automaton Intelligent Robot Protector of the present invention for cars and transportations is useful for solving these problems by reducing theft and crime activities and can provide better security and a peaceful society, and it can helps injured passengers.

### BRIEF DESCRIPTION OF THE DRAWINGS

All of the objects of the invention will become more apparent to the description below with reference to the drawings, wherein:

FIG. 1 is a stylized schematic view showing the components of the invention device.

FIG. 2 is a stylized schematic view showing the computer control center of the device of the invention.

FIG. 3 is a stylized schematic view showing the control power with relay switch, digital high low frequency dial method, input, and output video information transfer to adapter that connects to the computer control center and video camera.

FIG. 4 is a stylized schematic view showing the server module units provided with video cameras, Sensors, and GPS (global position system) for transferring the input signal to the adapter for connecting with peripheral processors in the computer control center.

FIG. 5 is a stylized schematic view showing the Authenticate Encryption Processor Security Hardware with ability for listening to specific Radio wave frequency, and Digital signal channel.

FIG. 6 is a stylized schematic view showing the Car having been stolen, and the Robot Protector makes a video cell phone call to the owner, together with a video showing the theft and the road that the car is located.

FIG. 7 is a stylized schematic view showing that the Robot can make a short brief report by display Codes. It can display text message in codes that represent the situations, such as CODE 1 for possible theft, CODE 2 for possible crime, and CODE 3 for possible accident etc.

FIG. 8 is stylized schematic view showing the User Interface and the sample programming command list to download to a micro controller in the computer control center may also have programs saved to an external memory.

FIG. 9 is a stylized schematic view showing in the Car accident, the Robot Protector can make cell phone call to Medical 911, sending video information of injured passenger situation, so that the medical response can send the rescue team with clear knowledge of what should be prepared and where the accident is located.

FIG. 10 is a stylized schematic view showing the simple model of the Automaton Intelligent Robot Protector and its complete operation.

### DESCRIPTION OF THE PREFERRED INVENTION DEVICE

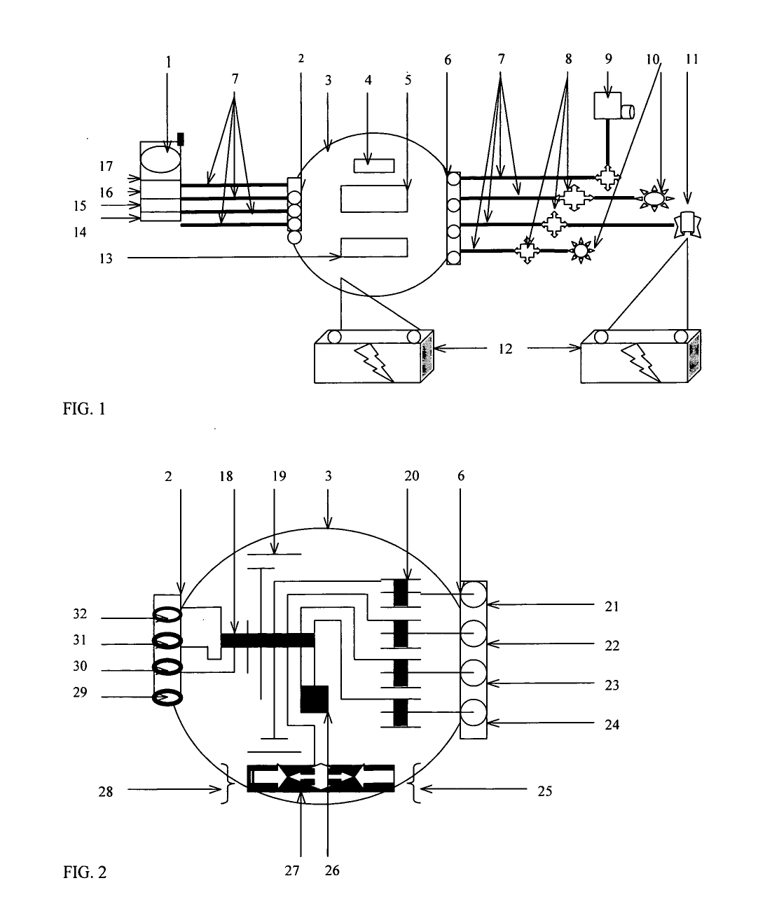

Referring to FIG. 1, illustrating the components of the device of the present invention, the device which includes a computer control center 3 having a main computer system 5 with adapters 2, and 6 which are attached to and for controlling server modules 8 that are connected with sensors 10, video cameras 9, GPS 11, and video cell phone communication channels 1. The center unit has a user interface 4 to allow human and machine for programming the robot and save the command program in the micro controller and external memory within the main computer system 5. The robot is also equipped with an authenticated encryption process secure hardware unit 13 that is operative to activate the robot securely. Rechargeable Batteries 12 show power source can be obtained from the transportation's power source or alternatively from and independent source. The batteries may also be charged with another battery, solar cell, and electric generator or other power charging methods.

Referring to FIG. 2, the main computer system 5 includes input, output port device adapters 21, 22, 23, 24, 6 and an authenticate encryption hardware unit 13 inside the computer control center 3. In the drawing a Micro controller 18 serves as the brain of the robot device It communicates with IC peripherals processors unit 20 and through adapter connections ports 21, 22, 23, 24, to the server modules 8 that can be attached to handle one to many sensors 10, video cameras 9, GPS 11 signals. The module 8 operates as a one unit server representing the device that is attached to and sequentially passing the sensors signals to the IC peripheral processors 20 to the micro control 18 to consistently monitor awareness of each modules 8 unit's situation. The authenticate encryption process secure hardware 13, has the ability to listen to specific encryption password signal by radio wave listener 27, or digital signal listener 25. Once the correct encryption password is received, the unit 26 will proceed with the secure robot activation steps. The adapter input, output ports 29, 30, 31, 32, 2 are used to communicate with the video cell phone 1.

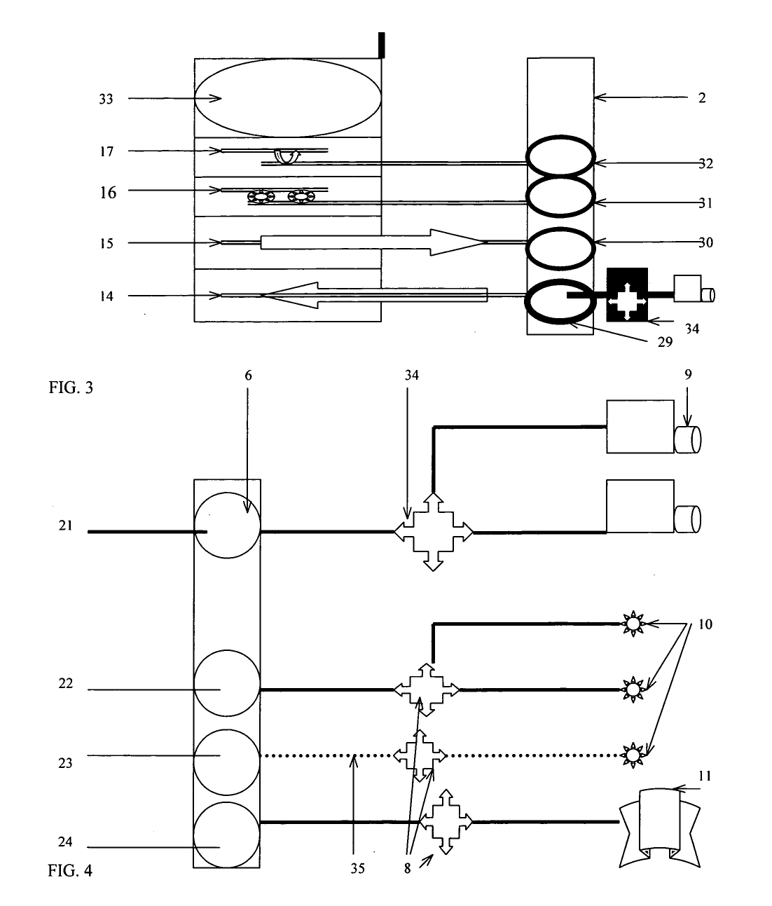

Referring to FIG. 3, the drawing shows the provision of a power relay switch 17 for powering on the cell phone, through port 32 which is connected to the IC to the micro controller 18, and to the digital dialer 16 through port 31. The switch 17 also connects the video cell phone income signals through port 30 to phone IC Peripheral and the Video input 14 through port 29 which also be module 34 as video cameras server to sequentially pass camera's signal to the cell phone directly, and the cell phone in turn transmits the video to the other cell phone.

Referring to FIG. 4, the drawing shows the Video server module attached to multiple video cameras and acting as a video server sequentially passing the video signal to port 21, the signal could be used by the phone IC peripheral 29 to cell phone and main computer system 5. The sensor module 8 can attach sensors and pas the signal to IC to have micro controller 5 to use the signal. GPS system can be connected to main control center by the port 24. The connection can be made with wire cable or by wireless means 35.

Referring to FIG. 5, which shows the authenticate encryption process secure hardware 27, and the unit embedded encryption processors 38 for verifying the received password. The unit has a built-in Radio wave receiver 28 that can listen for encryption password by specific radio frequency 39, and a digital signal receiver 25 that can listen for encryption password by specific digital signal channels.

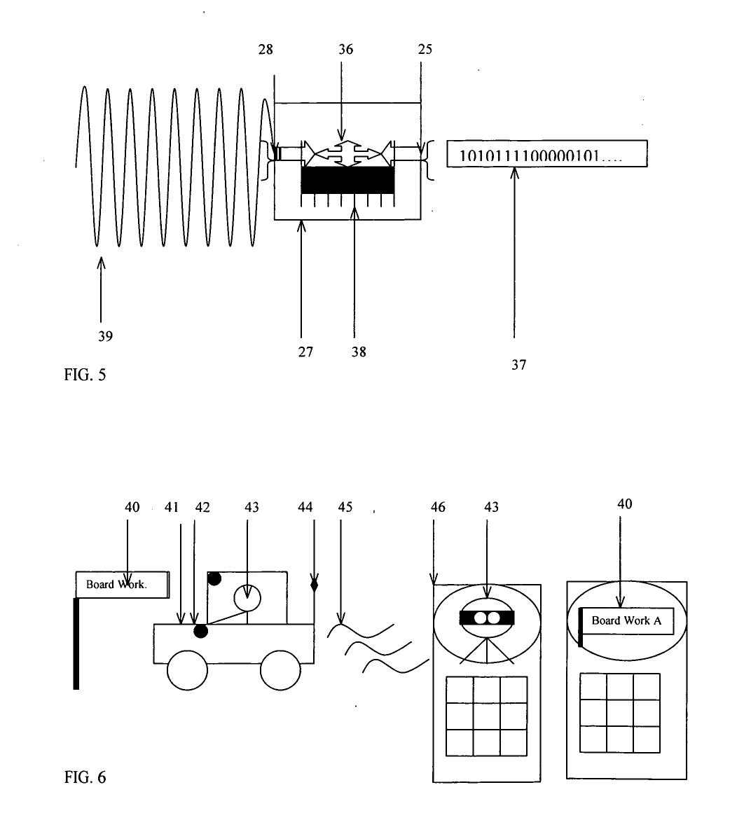

Referring to FIG. 6, the drawing shows the stolen car 41, the robot device uses an external video and internal video hidden in the driver control panel for taking video of both inside the car and the outside surrounding of the car; and it makes a video cell phone call to the owner's video phone 46, as well as showing on the video screen of the owner's video phone 46 the theft 43 and the outside road view of the car 40 so that the owner can use the information to guess where the car is located.

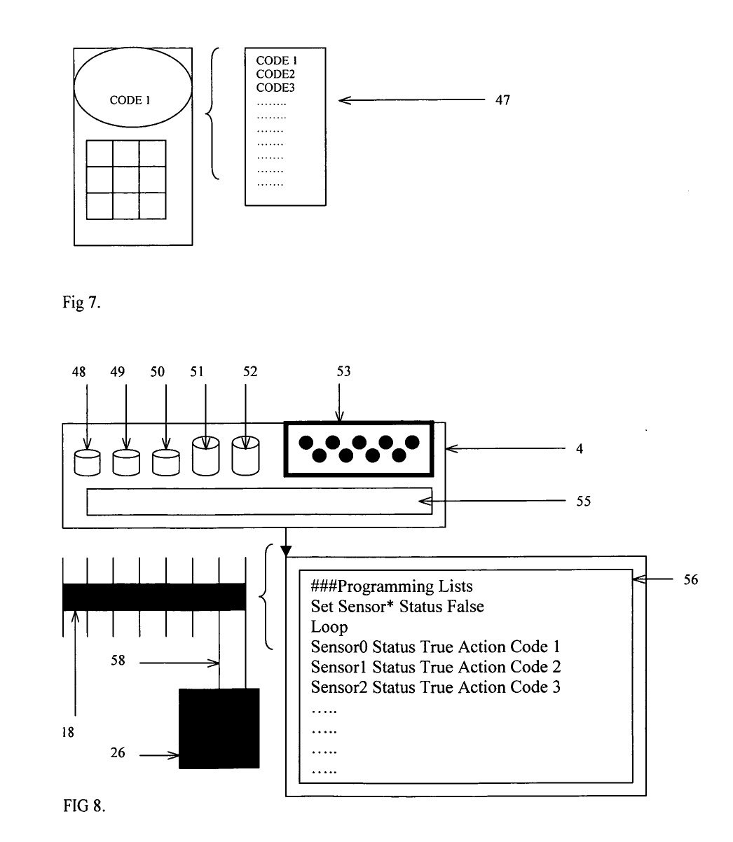

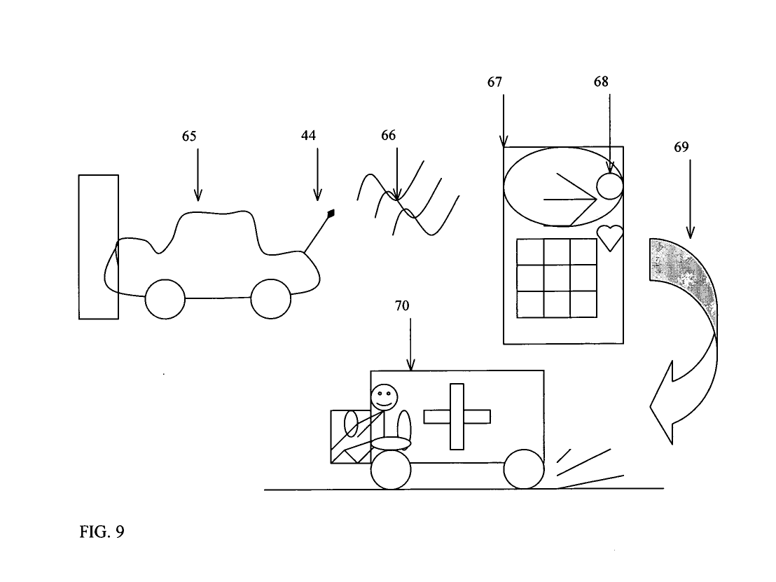

Referring to FIG. 7, it shows the video cell phone can transfer text code 47 for short brief report of the detect situation, for example, CODE 1 for possible theft, CODE 2 for possible crime activates, and CODE 3 for possible accident. The GPS information can provide the current location information, so that the owner can know the location of the transportation.

Referring to FIG. 8, the drawing shows the user interface 4 inside the computer control center 3, which includes manual buttons 48, 49, 50, 51, 52. The user can by operating the buttons and with simple setup establish the command and status of what action to do and who to call etc. If require complex programming command list setup, the user can use port 53 for machine or other computer to download the program to the robot. LCD 55 provides the display of the user's input command and programming list command information. The sample robot's program lists 56 shows the programming being downloaded to the micro controller 18 and also being saved to the external memory 26.

Referring to FIG. 9, it shows that the car 65 has an accident and the passenger 68 is unconscious. The robot makes the video cell phone call 66 with antenna 44 to medical 911 video phone 67. The medical 911 operator 69 accepts the video call and passes the video information to the rescue team 70 such that the rescue team would have a clear idea of the accident and it's location.

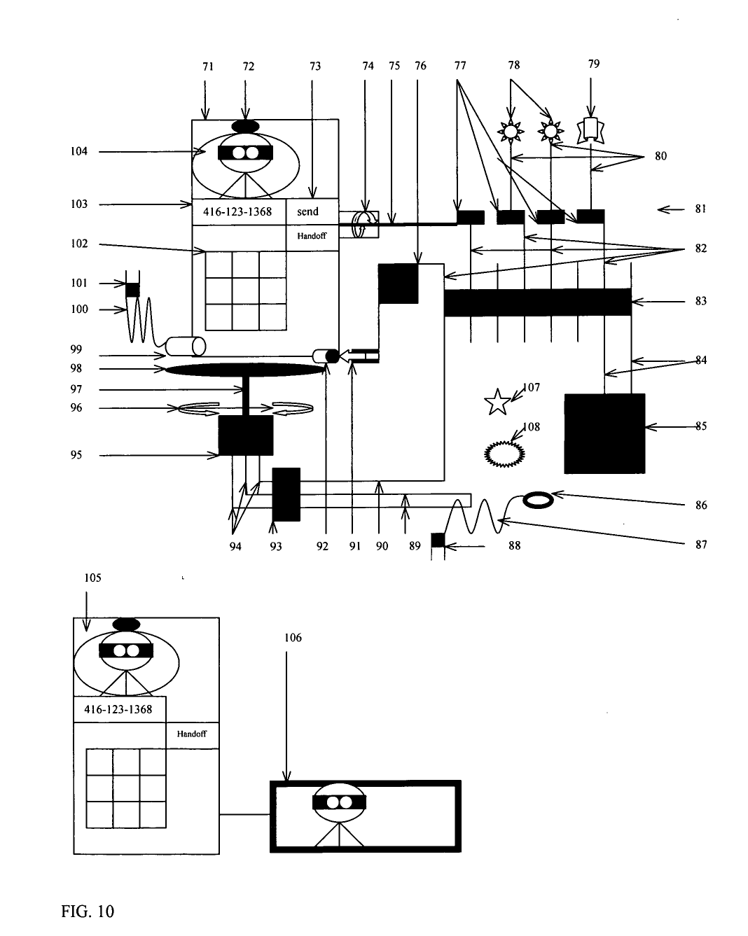

Referring to FIG. 10 which shows the robot is provided with Micro Controller 83, Sensors IC peripherals 77 for sensors 78 (which may be light sensor, touch sensor, sonar sensor, rotation sensor, video visual vision camera sensor, temperature sensor, sound sensor, ultrasonic sensor, infrared sensor, motor speed sensor, pressure sensor, angle degree sensor, etc all kind of sensors). External Memory 85 such as Flash memory, reprogramable memory, and other kinds of memory. Phone IC peripherals 76 for 3 sections pin connector (for voice input, voice output, power/signal from cell phone earphone adapter 92). Motor IC peripheral 93 for motor 95 (which may be servo motor, DS motor, step motor, etc all kind motor). The Micro Controller 83 is connected to IC peripherals 77 by circle lines 82 and it is able to control the incoming and out coming signals from sensors. The Micro Controller 83 can monitor the phone connection by connecting the phone IC peripheral 76 with the 3 sections pin 91 plug into the cell phone earphone socket 92. The main control center 81 has power source connector 86, power line 87, and power plug 88. The micro controller 83 is connected to Motor IC peripheral 93 which can control the motor 95 with 3 lines (2 power lines, 1 signal line). The motor 95 has a rotatable pin 97 connecting with the dish plate cell phone holder 98, and the rotate direction can be controlled in both directions 96. The phone has power connector 99, power line 100, and power plug 101. The user can setup a selected phone to call with push phone buttons 102, and the phone memory will automatically make the call number 103. When Sensors 78 detects irregular singles, and the Micro controller 83 is activated for the phone to dial by relay switch method 74 for sending the call to the owner. The video cell phone has video enable 72, and video cell phone 71 broadcast the video information of Possible Theft to the other cell phone 105 which has a computer, or recording machine 106 to receive the video information being recorded. Once the receive cell phone 105 is hung up, the phone connection will discontinue the Micro Controller 83 diagnostic to disconnect the line dial tone signals from the earphone plug 92 through the 3 section pin 91. The micro controller 83 activates the relay switch 74 again to hang up the cell phone 71. The Automaton Intelligent Robot Protector will return back to the monitor mode, and watch for next allergen signals. The GPS 79 function may be attached, if precise location is required. The Robot device has self-checking 107 modules that shows the working condition of the systems for verifying the robot working condition to the user. The robot device can be installed with the authenticate encryption process security hardware unit 108 for activating robot requiring any special need. The Automaton Intelligent Robot Protector can be built in many types of shapes to fit the installation need, and separate videos, sensors, motors as many as need may be provided to satisfy the protection purpose. The simple Robot Protector model can be built into a single video cell phone shape with all the functions required.

The invention of the intelligent robot device is able automatically to make security video cell phone calls for all cars, transportation on main use purpose area; in addition, the robot device can be used in other properties such as warehouse, buildings, houses, and inside an isolate security room for providing security protection in the same manner.

With the invention described and illustrated in the above preferred embodiments, it is to be understood that it is not intended to be limited to such disclosure, and changes and modifications may be made therein within the scope of the following claims.

I claim:

1. A robot device applicable for monitoring a transportation carrier comprising: a center control unit including micro controllers, processor, memories and electable circle board components with input/output connector ports coupled to sensors modules, video cameras modules, GPS modules, and video cell phone modules, said various modules being operative with a center power source or separate integral power sources.

2. A robot device according to claim 1 incorporated in a cell phone and operative to provide two-way voice communications.

3. A robot device according to claim 2 operative to dialogic to hang up a receiver's video cell phone to discount the communication, and upon detecting a phone discount to switch back to a monitor standard mode again.

4. A robot device according to claim 1 applicable to use selectively wire and wireless adapter connection methods to connect the device video cameras, sensors, units, and modules.

5. A robotic device according to claim 1 includes intelligent functions and attached as parts and accessories of the transportation carrier for automatic operation of video cell phone calls, and for transfer via video cell phone communication channels.

6. A robot device according to claim 5 including intelligent functions able to control video cameras shooting view direction and speed, and place cell phone holder rotation direction and speed by controlling the motors spin direction and speed.

7. A robot device according to claim 1 including a user interface that is able to accept user command programming download from machine or input buttons manual from human and save the setting program into memory, and when specific program conditions detected, the device can automatically do the actions what the program define and making video cell phone calls and broadcast video info and other tasks defined in the program without people's action.

8. A robot device according to claim 1 operative automatically to make security video cell phone calls for all cars, transportation on main use purpose area; in addition, the robot device can use where properties need to be protect such as warehouse, buildings, houses, and inside security room, etc where need this intelligent robot.

9. A robot device according to claim 1 including a switch means operative to activate a video cell phone to send call signals, and to direct make send command when the cell phone has select fix phone number to call and transfer real time video to another cell phone to alert notify and show the situation of the transportation carrier to the owner and selective parties.

10. A robot device according to claim 1 including necessary antenna to meet the communication method when the general video cell phone method is not available, the Robot device having self-checking modules that show the working condition of the systems to have user verify the robot working condition.
